(19) United States
(12) Patent Application Publication
(10) Pub. No.: US 2024/0092222 A1
(43) Pub. Date: Mar. 21, 2024

(54) METHOD FOR DISTRIBUTING BALANCING POWER

(71) Applicant: TOYOTA JIDOSHA KABUSHIKI KAISHA, Toyota-shi (JP)

(72) Inventors: Takaaki SANO, Izumi-shi (JP); Takafumi MATSUMURA, Ashiya-shi (JP)

(73) Assignee: TOYOTA JIDOSHA KABUSHIKI KAISHA, Toyota-shi (JP)

(21) Appl. No.: 18/467,391

(22) Filed: Sep. 14, 2023

(30) Foreign Application Priority Data
Sep. 16, 2022 (JP) 2022-147872

(51) Int. Cl. B60L 58/13; B60L 53/63; H02J 3/14

(52) U.S. Cl. CPC B60L 58/13; B60L 53/63; H02J 3/144

(57) ABSTRACT

A method for distributing balancing power, the method comprising, preferentially assigning, when a demand response is performed using a plurality of electrified vehicle groups including one or more electrified vehicles each of which includes a communication unit and a balancing resource that is able to supply power to an outside, an integral multiple of control power of each of the electrified vehicle groups to required balancing power required for each of the electrified vehicle groups in target balancing power within a limit of balancing power that each of the electrified vehicle groups is able to supply, and assigning remaining balancing power of the target balancing power to required balancing power required for another resource other than the electrified vehicles, after assigning integral multiple of control power of each of the electrified vehicle groups to required balancing power required for each of the electrified vehicle groups in the target balancing power.

### CROSS-REFERENCE TO RELATED APPLICATION

This application claims priority to Japanese Patent Application No. 2022-147872 filed on Sep. 16, 2022, incorporated herein by reference in its entirety.

### BACKGROUND

### 1. Technical Field

The present disclosure relates to a method for distributing balancing power.

### 2. Description of Related Art

Japanese Unexamined Patent Application Publication No. 2021-150988 (JP 2021-150988A) discloses a technique in which a power management device includes a selection unit that selects the target number of electrified vehicles from a vehicle group including a plurality of electrified vehicles, and a request unit configured to be able to request, for each electrified vehicle selected by the selection unit, at least one of charging of a power storage device using power of a power grid and power supply to the power grid, and the selection unit acquires a temperature and a state of charge (SOC) of the power storage device of each electrified vehicle included in the vehicle group, performs selection according to a predetermined priority order based on the temperature and the SOC of the power storage device, and changes a priority level in which a vehicle performing a demand response (DR) is assigned according to the SOC status.

### SUMMARY

However, in a case where an electrified vehicle equipped with a communication unit such as a data communication module (DCM) is used as a part of a resource of balancing power, and is used together with other balancing resources, the least significant bit (LSB) is applied to control power when the DCM is provided on the vehicle. That is, when a vehicle (DR vehicle) used for a demand response (DR) is set using the DCM provided on the electrified vehicle, only an integral amount of power can be calculated as a balancing amount depending on the DCM specifications, and there is a possibility that the required balancing power of the target cannot be satisfied. Accordingly, even when the balancing power is distributed to the electrified vehicle, an error that cannot be controllably corrected is generated, and thus the required balancing power cannot be satisfied.

The present disclosure has been made in view of the above issue, and an object of the present disclosure is to provide a method for distributing balancing power in which balancing power is easily adjusted to target balancing power when the electrified vehicle including the communication unit and other balancing resources are used together as the resource of the balancing power.

A method for distributing balancing power, the method comprising:
preferentially assigning, when a demand response is performed using a plurality of electrified vehicle groups including one or more electrified vehicles each of which includes a communication unit and a balancing resource that is able to supply power to an outside, an integral multiple of control power of each of the electrified vehicle groups to required balancing power required for each of the electrified vehicle groups in target balancing power within a limit of balancing power that each of the electrified vehicle groups is able to supply; and
assigning remaining balancing power of the target balancing power to required balancing power required for another resource other than the electrified vehicles, after assigning integral multiple of control power of each of the electrified vehicle groups to required balancing power required for each of the electrified vehicle groups in the target balancing power.

According to the present disclosure, when the electrified vehicle including the communication unit and the other balancing resources are used together as the resource of the balancing power, the balancing power can be easily adjusted to the target balancing power of the electrified vehicle including the communication unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart illustrating a method of adjusting a distribution force according to an embodiment of the present disclosure.

### DETAILED DESCRIPTION OF EMBODIMENTS

Hereinafter, an embodiment of the present disclosure will be described below with reference to the drawings. The present disclosure is not limited by the embodiments described below.

According to the technique of the present embodiment, it is possible to solve the problem that an error that is difficult to correct is generated in terms of control even if the balancing power is distributed to electrified vehicle without considering the power units that can be controlled by electrified vehicle (DCM mounted vehicles) equipped with DCM as the communication unit, and the required balancing power cannot be satisfied.

In order to solve this problem, the method of distributing the balancing power according to the present embodiment is a method in which, when the required balancing power is distributed to the resources, the request to DCM mounted vehicles is distributed to DCM group divided by the controllable power unit by a multiple of the integral power unit that can be controlled for each DCM group, and the fraction and the shortage are distributed to the other resources. In addition, the distribution quantity is determined preferentially from among DCM groups in which the controllable power units are large. Further, in the present embodiment, calculation and control are executed by balancing power calculation unit included in a control unit of an information processing apparatus managed by an aggregation coordinator, a resource aggregator, or the like. The resource aggregator is a business operator that directly concludes a service contract with a customer and Virtual Power Plant (VPP) and performs resource control. The aggregation coordinator is a business operator that bundles the amount of electric power controlled by the resource aggregator and directly conducts electric power transactions with a general power transmission and distribution business operator or a retail electric power business operator.

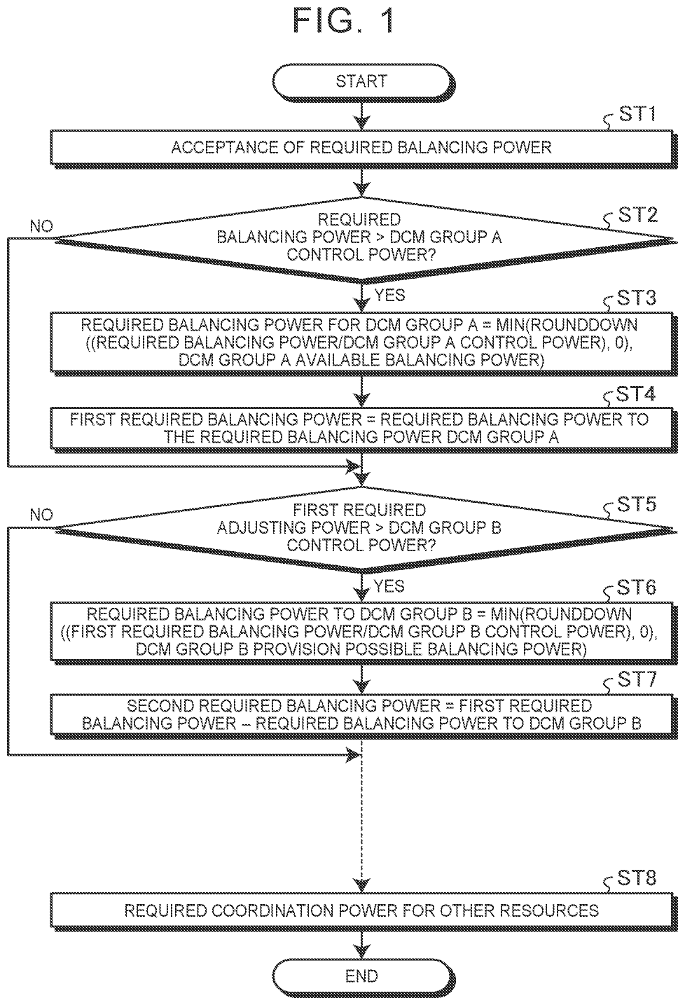

A method of adjusting a distribution force according to the embodiment of the present disclosure will be described. FIG. 1 shows a flowchart for explaining a method of adjusting a distribution force according to the embodiment of the present disclosure. As shown in FIG. 1, first, in ST1, the balancing power calculation unit accepts the required balancing power.

Next, in ST2, the balancing power calculation unit determines whether or not the required balancing power is larger than the control power of DCM group A (hereinafter, referred to as DCM group A control power or the like). Here, the magnitude relation of the magnitude of the control power of DCM group is expressed by the following equation (1).

DCM group A(maximum control power of DCM group)>DCM group B>DCM group C>DCM group D> . . . >DCM group Z(minimum control power) (1)

When the balancing power calculation unit determines that the required balancing power is larger than DCM group A control power (ST2:Yes), the process proceeds to ST3. In ST3, the balancing power calculation unit sets the required balancing power for DCM group A based on the following equation (2-A).

Required balancing power to DCM group A=MIN(ROUNDDOWN((required balancing power/DCM group A control power),0),DCM group A available balancing power) (2-A)

(2-A) The expression indicates that the integral value (integer part (decimal truncation)) of the quotient obtained by dividing the required balancing power by DCM group A control power and the balancing power that can be provided by DCM mounted vehicles of DCM group A are not large. Hereinafter, description of the same formulae will be omitted. The balancing power calculation unit selects an integral part of the quotient obtained by dividing the required balancing power by DCM group A control power and the balancing power that can be provided by DCM group A not to be large.

Next, shifting to ST4, the balancing power calculation unit subtracts the required balancing power for DCM group A derived by the equation (2-A) from the required balancing power accepted in ST1, as shown in the following equation (3-A). The first required balancing power is determined based on the following equation (3-A):

First required balancing power=required balancing power−required balancing power to DCM group A (3-A)

When the balancing power calculation unit determines that the required balancing power is equal to or less than DCM group A control power from ST4 or in ST2 (ST2:No), the process proceeds to ST5.

Moving to ST5, the balancing power calculation unit determines whether the first required balancing power determined by the equation (3-A) is larger than DCM group B control power. In ST5, when the balancing power calculation unit determines that the required balancing power is larger than DCM group B control power (ST5:Yes), the process proceeds to ST6. In ST6, the balancing power calculation unit sets the required balancing power for DCM group B based on the following equation (2-B).

Required balancing power to DCM group B=MIN(ROUNDDOWN((required balancing power/DCM group B control power),0),DCM group B available balancing power) (2-B)

Next, the process proceeds to ST7, and the balancing power calculation unit subtracts the required balancing power for DCM group B derived by the equation (2-B) from the first required balancing power derived in ST4, as shown in the following equation (3-B). The second required balancing power is determined based on the following equation (3-B):

Second required balancing power=first required balancing power−required balancing power to DCM group B (3-B)

In ST5, when the balancing power calculation unit determines that the first required balancing power is equal to or less than DCM group B control power in ST5 (ST5:No), the process proceeds to ST7 subsequent steps.

After ST7, DCM group C, DCM group D, . . . DCM group Z and the last DCM group, the third required balancing power, the fourth required balancing power, . . . ST5 to ST7 is repeatedly executed until the nth required balancing power (n is the number of DCM groups) is derived.

After the determination of the magnitude with respect to the required balancing power for the last DCM group Z and the setting of the required balancing power are completed, the process proceeds to ST8. In ST8, the balancing power calculation unit outputs the last required balancing power to other balancing resources other than DCM mounted vehicles. In this way, DCM group A to DCM group Z are DR by DCM mounted vehicles and DR for the additional balancing resource.

According to the embodiment of the present disclosure described above, when DCM mounted vehicle and the other balancing resources that are electrified vehicle as the balancing power resources are used together, the balancing power can be easily adjusted to the target balancing power of DCM mounted vehicle.

Although the embodiment of the present disclosure has been specifically described above, the present disclosure is not limited to the above-described embodiment, and various modifications based on the technical idea of the present disclosure and embodiments combined with each other can be adopted. Further effects and modifications can be easily derived by those skilled in the art. The broader aspects of the present disclosure are not limited to the particular details and representative embodiments shown and described above. Accordingly, various modifications can be made without departing from the spirit or scope of the general inventive concept as defined by the appended claims and their equivalents.

What is claimed is:

1. A method for distributing balancing power, the method comprising:
preferentially assigning, when a demand response is performed using a plurality of electrified vehicle groups including one or more electrified vehicles each of which includes a communication unit and a balancing resource that is able to supply power to an outside, an integral multiple of control power of each of the electrified vehicle groups to required balancing power required for each of the electrified vehicle groups in target balancing power within a limit of balancing power that each of the electrified vehicle groups is able to supply; and
assigning remaining balancing power of the target balancing power to required balancing power required for another resource other than the electrified vehicles, after assigning integral multiple of control power of each of the electrified vehicle groups to required balancing power required for each of the electrified vehicle groups in the target balancing power.
